(19) United States
(12) Patent Application Publication
(10) Pub. No.: US 2010/0131322 A1
(43) Pub. Date: May 27, 2010

(54) System and Method for Managing Resources that Affect a Service

(75) Inventors: Venkata R. Koneti, Adhra Pradesh (IN); Ramanjaneyulu Malisetty, Andhra Pradesh (IN); Ranga R. Makireddy, Andhra Pradesh (IN)

Correspondence Address: BAKER BOTTS L.L.P., 2001 ROSS AVENUE, SUITE 600, DALLAS, TX, 75201-2980, US

(73) Assignee: Computer Associates Think, Inc., Islandia, NY (US)

(21) Appl. No.: 12/276,170

(22) Filed: Nov. 21, 2008

(51) Int. Cl. G06Q 10/00

(52) U.S. Cl. 705/8

(57) ABSTRACT

In accordance with one embodiment of the present disclosure, a method for managing a service includes monitoring, by one or more agents, the use of one or more tools by one or more workers. Each worker can have one or more assigned tasks corresponding to a service. In this example, metrics are collected corresponding to the monitored use of the tools by the workers. The metrics can be analyzed by a service analysis engine. In some embodiments, the service analysis engine may be embodied in computer-readable medium. In some cases, a report can be generated by the service analysis engine, which report can be based at least in part on the analyzed metrics. At least a portion of the report can be communicated to at least one worker.

### TECHNICAL FIELD

This disclosure relates in general to management of services, and more particularly to a system and method for managing resources that affect a service.

### BACKGROUND

Various project management tools exist that assist users in dealing with the complexity of large projects. Such tools in the form of software applications typically require a human user to enter data in the form of events, scheduling, resource allocation, and critical paths that ultimately may determine whether the project is completed on time and in a satisfactory manner. Because the accuracy and reliability of this data is dependent on the input from a human user, it is typically prone to errors in data entry, miscalculations, and erroneous estimates. Moreover, such tools often require a human user to update the progress of the project, which may compound or even multiply similar error factors.

### SUMMARY

In accordance with one embodiment of the present disclosure, a method for managing a service includes monitoring, by one or more agents, the use of one or more tools by one or more workers. Each worker can have one or more assigned tasks corresponding to a service. In this example, metrics are collected corresponding to the monitored use of the tools by the workers. The metrics can be analyzed by a service analysis engine. In some embodiments, the service analysis engine may be embodied in computer-readable medium. In some cases, a report can be generated by the service analysis engine, which report can be based at least in part on the analyzed metrics. At least a portion of the report can be communicated to at least one worker.

Depending on the specific features implemented, particular embodiments of the present invention may exhibit some, none, or all of the following technical advantages. Various embodiments may include a Service Analysis Engine that can act as a semi-automated or fully-automated management support system. In some embodiments, the Service Analysis Engine may analyze the use of tools by workers, such as human resources, and generate reports accordingly. The reports may be used, for example, to optimize the rendering of services, to improve the quality of services, to determine the costs associated with rendering service and potential methods of reducing such costs, and to determine whether or not to continue an existing service.

Other technical advantages of the present disclosure will be readily apparent to one skilled in the art from the following FIGURES, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and its advantages, reference is now made to the following description, taken in conjunction with the accompanying drawings, in which:

FIG. 1 is a block diagram of a system for managing resources that affect a service according to one embodiment;

FIG. 2 is a block diagram illustrating a Service Analysis Engine that forms a portion of the system of FIG. 1; and

FIG. 3 is a flowchart illustrating acts related to managing the rendering of a service the Service Analysis Engine of FIG. 2.

### DETAILED DESCRIPTION

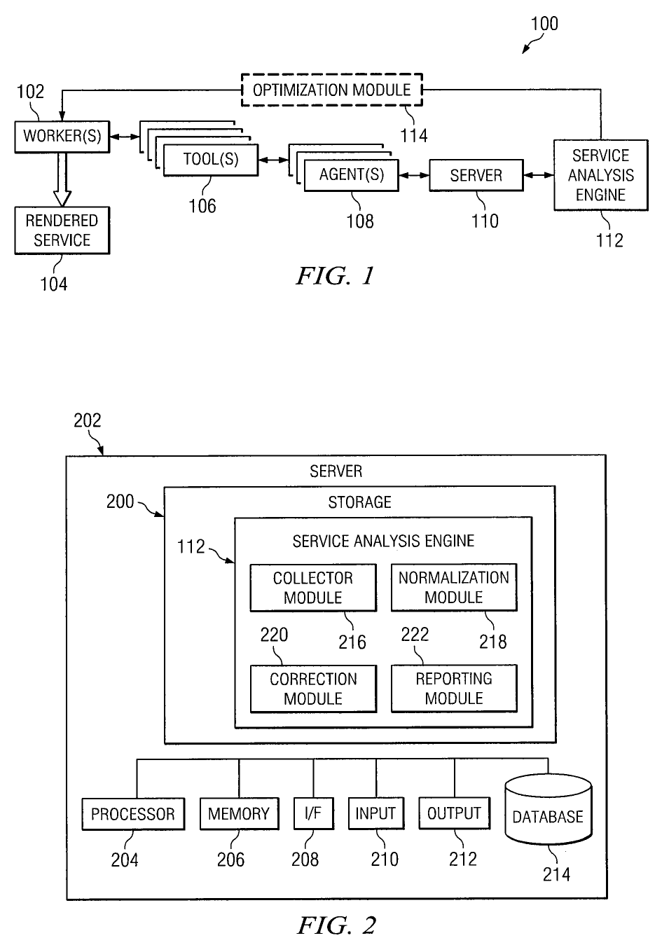

The example embodiments of the present disclosure are best understood by referring to FIGS. 1 through 3 of the drawings, like numerals being used for like and corresponding parts of the various drawings.

FIG. 1 is a one embodiment of a block diagram of a system 100 for managing resources that affect a service. In this example, system 100 includes one or more workers 102 capable of collectively or individually rendering a service 104 by using, at least in part, one or more tools 106. In this embodiment, one or more agents 108 collect data corresponding to the use of tools 106 by workers 102. Agents 108 may communicate the collected data to a server 110. As explained further below, a Service Analysis Engine 112 analyzes the data collected by agents 108 and performs acts that may be useful, for example, in optimizing the rendering of service 104 by system 100, improving the quality of service 104, determining the costs associated with rendering service 104 and potential methods of reducing such costs, or determining whether or not to continue an existing service.

Throughout the present disclosure the use of the words “workers,” “tools,” and “agents,” in plural form may be taken as reference to more than one (plural) worker, tool, or agent, respectively, or one (singular) worker, tool, or agent, respectively. Furthermore, the term “or” as used herein is generally intended to mean “and/or” unless otherwise indicated.

In this example, workers 102 refer to any resource(s) capable of performing acts to further the rendering of service 104. In some embodiments, workers 102 may include human resources, such as, for example, human resource recruiters, software developers, or electrical engineers. Non-human workers 102 may include, for example, specialized machinery or intelligent software capable of executing instructions.

Some examples of service(s) 104 rendered by the individual or collaborative acts of 102 may include: the execution of a business process involving the interviewing and recruitment of a new employee; the drafting of documents; the design, maintenance, or production of software, hardware, or firmware services or products; any combination of the preceding; or any other suitable service that may be executed, at least in part, by workers 102. In most cases, the acts performed by workers 102 to further the rendering of service 104 include the use of tools 106.

In various embodiments, tools 106 generally refer to any software, hardware, or firmware workers 102 may use to further the rending of service 104. For example, if the particular service 104 is software related, at least some of the tools 106 used by workers 102 may be software applications. More specifically, a worker 102 acting in her capacity has a software developer may use software applications to perform the acts of designing, coding, debugging, or testing various software modules that form a part of service 104. Some examples of such software applications may include: source code editors; Eclipse; Concurrent Versions System (CVS); Ant; a web browser; any combination of the preceding; or any other suitable software application, including future applications, useful in furthering the rendering of service 104.

Agents 108 may refer to any entity or entities capable of monitoring the use of tools 106 by workers 102. For example, an agent 108 may include software “sensors” capable of collecting raw data or “metrics” corresponding to the use of tools 106 by workers 102. In some embodiments, such raw data may include at least the following: the number of lines of computer code successfully compiled by a worker 102; the amount of time a worker 102 spent using a particular software application; the amount of time a worker 102 spent editing a particular computer file; the Uniform Resource Locators (URL) visited by a worker 102; whether a worker 102 has obtained approval for acts or work product completed by the worker 102; any combination of the preceding; or some other information or metric corresponding to the use of tools 106 by workers 102.

Agents 108 may reside at any suitable location. For example, agents may reside within a server or computer workstation that may be remotely or locally accessed by workers 102 for the purpose of using tools 106. Although some such agents(s) 108 may reside locally with respect to corresponding tools 106, some other agents 108 may reside remotely from their corresponding tools 106.

In some embodiments, each agent 108 may monitor a particular use of a respective tool 106; however, in some other embodiments any given agent 108 may alternatively monitor the use of multiple tools 106, or any given agent may monitor multiple uses of the same tool 106. In addition, some tools 106 may be monitored by multiple agents 108. In the illustrated example, agents 108 communicate to server 110 the information obtained from monitoring the use of tools 106 by workers 102.

In this example, server 110 refers to any entity capable of receiving information from agents 108. Server 110 may be, for example, a file server, a domain name server, a proxy server, a web server, an application server, a computer workstation, a handheld device, or any other device operable to communicate with agents 108. Server 110 may execute with any of the well-known MS-DOS, PC-DOS, OS-2, MAC-OS, WINDOWS™, UNIX, or other appropriate operating systems, including future operating systems. In some embodiments, server 110 may maintain a repository of empirical data corresponding to each worker 102. The repository may include, for example, respective histories of the prior use of tools 106 by workers 102, as previously reported by agents 108. As shown in FIG. 1, server 110 is in communication with Service Analysis Engine 112, which may reside internal or external to server 110.

The communication between workers 102, tools 106, agents 108, server 110, or Service Analysis Engine 112 may be effected by any interconnecting system capable of transmitting audio, video, signals, data, messages, or any combination of the preceding. Such interconnecting systems may include, for example, all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication link, or any combination of the preceding.

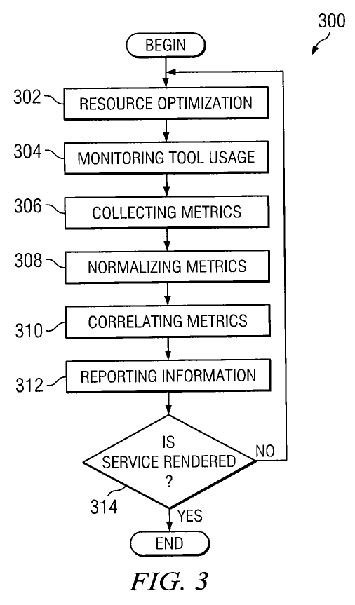

In operation, Service Analysis Engine 112 operates as a semi-automated or fully-automated management support system. More specifically, Service Analysis Engine 112 may analyze the use of tools 106 by workers 102 and generate reports accordingly. The reports may be used, for example, to optimize the rendering of service 104 by system 100, to improve the quality of service 104, to determine the costs associated with rendering service 104 and potential methods of reducing such costs, and to determine whether or not to continue an existing service. Additional detail regarding example structure and function of Service Analysis Engine 112 are explained further below with reference to FIGS. 2 and 3.

FIG. 2 is one embodiment of a block diagram illustrating a Service Analysis Engine 112 that forms a portion of the system 100 of FIG. 1. In this example, Service Analysis Engine 112 resides in storage 200 of server 202; however, Service Analysis Engine 112 may reside at or within any suitable location, including, for example, within server 110 of FIG. 1, a computer workstation or handheld computer, embodied in computer-readable medium, or at any other suitable location.

In the illustrated example, server 202 includes at least the following: a processor 204, memory 206, an interface 208, input functionality 210, output functionality 212, and database 214; however, servers 110 and 202 may have any other suitable structure. Server 202 may be, for example, a file server, a domain name server, a proxy server, a web server, an application server, a computer workstation, a handheld device, or any other device operable to communicate with Service Analysis Engine 112. Server 202 may execute with any of the well-known MS-DOS, PC-DOS, OS-2, MAC-OS, WINDOWS™, UNIX, or other appropriate operating systems, including future operating systems. In some embodiments, server 202 may have the same structure and function as server 110. In some other embodiments, the functions of servers 202 and 110 may be integrated into a single server.

In this example, database 214 operates to store data, and facilitates addition, modification, and retrieval of such data. In some embodiments, database 214 may store at least a portion of the information communicated by agents 108. Database 214 may include, for example, an XML database, a Configuration Management Database (CMDB) database, or any other suitable database having any of a variety of database configurations, including future configurations. Although database 214 resides within server 202 in the example embodiment, database 214 may alternatively reside separate from server 202.

In this example, Service Analysis Engine 112 includes at least a Collector Module 216, a Normalization Module 218, a Correlation 220, and a Reporting Module 222. In one particular embodiment, modules 216, 218, 220, and 222 operate to perform one or more acts related to analyzing the data collected by agents 108 and generating reports in connection with such analysis. Although the illustrated example includes modules 216, 218, 220, and 222, the acts performed by Service Analysis Engine 112 may be divided into any other suitable number of modules, or may be contained in one module.

In one embodiment, Collector Module 216 receives the information communicated by agents 108 and can parse, format, or store the received information (e.g., Collector Module 216 may store the information within database 214). Normalization Module 218 can normalize the information received by Collector Module 216. For example, the information communicated by agents 108 may correspond to various different workers 102, each of which may use any of a variety of different tools 106. In some such embodiments, Normalization Module 218 may determine, for example, whether the received data corresponds to a particular worker 102, a particular tool 106, a set of workers 102, or a set of tools 106, each of which may be correlated by one or more factors. In some embodiments, the factors that may correlate workers 106 or tools 102 may be predetermined and communicated to Service Analysis Engine 112 prior to, or in connection with, the execution of service 104. In some alternative embodiments, such correlative factors may be dynamically determined by Normalization Module 218 based at least in part on the information received by Collector Module 216.

In various embodiments, Correlation Module 220 can modify the normalized data into a form that facilitates analysis of the data and may perform at least a portion of the data analysis. The analysis can include the application of one or more rules or algorithms to the data collected by agents 108. In some embodiments, such rules or algorithms may be dynamically derived, at least in part, from the past performance of workers 102 or tools 106, as monitored by agents 108 and stored by Collector Module 216. Several example acts that may be performed by Correlation Module 220 are described below; however, these examples are for illustrative purposes and not an exhaustive list of all the acts that may be performed by Correlation Module 220.

In a first example, Correlation Module 220 may determine the total cost incurred to render service 104. To illustrate, a worker 102 may spend a total of eight hours using different tools 106 to deliver a service. Correlation Module 220 may calculate the cost associated with the time the worker 102 spent rendering service 104 in addition to the apportioned costs, if any, associated with the use of tools 106. In some embodiments, future costs anticipated for a proposed service 104 may be extrapolated based at least partly on past performance of one or more workers 102 and the anticipated cost of using tools 106.

In a second example, Correlation Module 220 may determine the quality of a rendered service 104. In making this determination, Correlation Module 220 may receive or generate metrics describing the quality of service 104. Such metrics may include, for example, the time the service was completed relative to customer commitments, the total cost, customer satisfaction, any combination of the preceding, or any other suitable quality metric. The evaluation of such quality metrics by Correlation Module 220 may enable Service Analysis Engine 112 to determine, for example, if a particular worker 102 is able to use a particular tool 106 efficiently.

In a third example, Correlation Module 220 may determine whether to continue an existing service 104. In making this determination, Correlation Module 220 may consider any of a variety of factors, such as, for example, the availability of workers 102, the anticipated consumption of worker 102 and tool 106 resources necessary to maintain the service 104 in question, any combination of the preceding, or any other suitable factor.

In a fourth example, Correlation Module 220 may recognize that a particular set of workers 102 have used tools 106 less effectively during a given time period, as compared to an analogous time period in the past. Correlation Module 220 may analyze the data associated with the set of workers 102, both individually and collectively, and the data associated with the tools 106, in an attempt to determine clues as to the source of the discrepancy. Correlation Module 220 may then form the conclusion, for example, that the source of the discrepancy is a change in performance of one or more workers 102, the malfunction or poor performance of one or more tools 106, some combination of the preceding, or some other issue.

In a fifth example, Correlation Module 220 may estimate how much time a particular worker 102 will likely spend completing an assigned task. The estimation may be at least partially based on the past use of tools 106 by that worker 102. Correlation Module 220 may use this estimation, for example, to determine whether the worker 102 will complete the assigned task within a predetermined timeframe. If Correlation Module 220 determines the task will not be completed on time, Correlation Module 220 may consider how the delinquency of the task will affect the final delivery time or quality of the service 104 relying on that task. Correlation Module 220 may also determine whether adding one or more workers 102 to the same task will cure the expected delinquency or otherwise improve the final delivery time or quality of the service 104; and Correlation Module 220 may also determine whether additional workers 102 are available based at least in part on their past use of tools 106.

In the illustrated example, Reporting Module 222 operates to create a report based at least in part on the modification or analysis of the data performed by Correlation Module 220. The reports may be used, for example, to optimize the rendering of service 104 by system 100, to improve the quality of service 104, to determine the costs associated with rendering service 104 and potential methods of reducing such costs, and to determine whether or not to continue an existing service 104. For example, the Reporting Module 222 may generate a report, (e.g., in response to the analysis performed by Correlation Module 220), which may be used to modify the work performed by workers 102. Some such reports may be used to perform automated management of system 100, without further human intervention, in a way that enhances the efficiency and quality of service 104. This automated management of system 100 may occur dynamically while a particular service 104 is being rendered and may be in direct response to the work or input provided by workers 102 toward service 104.

In some embodiments, Reporting Module 222 may communicate periodic feedback directly to workers 102 in a way that affects how the workers 102 further the rendering of service 104. In some other embodiments, Reporting Module 222 may communicate reports to the Optimization Module 114 of FIG. 1, which may then determine whether or not workers 102 should receive new instructions or assignments. Such an Optimization Module 114 may be a portion of Service Analysis Engine 112, a portion of some other engine, or may include one or more human resources (e.g., service managers) who interpret the report and take actions accordingly. Such human actions may include, for example, endorsing the automated management of system 100, as recommended by Service Analysis Engine 112.

FIG. 3 is one example of a flowchart 300 illustrating steps related to managing the rendering of a service 104 by the Service Analysis Engine 112 of FIG. 2. In this example, Service Analysis Engine 112 can loop through at least the following steps until a service 104 is rendered or discontinued: optimizing resources 302, sensing tool 106 usage 304, collecting metrics 306, normalizing metrics 308, correlating metrics 310, and reporting information 312.

In this example, workers 102 and one or more tools 106 may be optimized in step 302. For example, Correlation Module 220 may determine how to divide among a set of workers 102 the execution of a newly requested service 104. Correlation Module 220 may consider at least the following examples in making this determination: the scope of service 104 in terms of delivery costs; the past performance of each worker 102 in the set; a completion deadline for service 104; whether, and to what extent, each worker 102 is presently occupied in furthering the rendering of other services 104; any combination of the preceding; or any of a variety of other pertinent considerations. Some embodiments, however, may not perform such an optimization step 302 at the onset of a newly requested service 104 and instead rely on human intervention for initialization of worker 102 and tool 106 resource allocation.

The use of tools 106 by workers 102 is monitored and corresponding metrics are determined in step 304. The monitoring of tool 106 usage may be performed, for example, in a manner substantially similar to that described above with reference to agents 108. In some embodiments, such monitoring may be unobtrusive and otherwise undetectable by workers 102 or tools 106.

The metrics determined in step 304 are collected in step 306, normalized in step 308, and correlated in step 310. The collection, normalization, and correlation of metrics may be performed, for example, in a manner substantially similar to those described above with reference to the collection of data by Collector Module 216, the normalization of data by Normalization Module 218, and the correlation of data by Correlation Module 220, respectively.

In this example, step 312 reports useful information that may have been determined, at least in part, in the course of the preceding steps 302, 304, 306, and 310. Such reporting may be performed, for example, in a manner substantially similar to that described above with reference to Reporting Module 312.

In this particular embodiment, a decision may be made in step 314 as to whether service 104 is completely rendered. If service 104 is complete, flowchart 300 loops such that resource optimization feedback may occur or reoccur in step 302; otherwise flowchart 300 ends.

Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A method for managing a service, comprising:
monitoring, by one or more agents, use of one or more tools by one or more workers, each worker having one or more assigned tasks corresponding to a service;
collecting metrics corresponding to the monitored use of the one or more tools by the one or more workers;
analyzing the metrics using a service analysis engine, the service analysis engine embodied in computer-readable medium;
generating a report, using the service analysis engine, the report based at least in part on the analyzed metrics; and
communicating at least a portion of the report to at least one worker of the one or more workers.

2. The method of claim 1, wherein the communicated report modifies an assignment of the one or more assigned tasks, the modification based at least in part on the analyzing of the metrics by the service analysis engine.

3. The method of claim 1, further comprising determining a level of efficiency, using the service analysis engine, for each worker of the one or more workers, the level of efficiency based at least in part on the analyzing of the metrics by the service analysis engine.

4. The method of claim 1, further comprising determining, using the service analysis engine, a level of quality for each worker of the one or more workers, the level of quality based at least in part on the analyzing of the metrics by the service analysis engine.

5. The method of claim 1, further comprising determining, using the service analysis engine, a fee for the service, the determination based at least in part on the analyzing of the metrics by the service analysis engine.

6. The method of claim 1, further comprising determining, using the service analysis engine, a level of efficiency for each tool of the one or more tools, the level of efficiency based at least in part on the analyzing of the metrics by the service analysis engine.

7. The method of claim 1, further comprising determining, using the service analysis engine, a level of quality for each tool of the one or more tools, the level of quality based at least in part on the analyzing of the metrics by the service analysis engine.

8. The method of claim 1, further comprising estimating, using the service analysis engine, whether or not each worker will timely complete each task of the one or more assigned tasks, the estimation based at least in part on the analyzing of the metrics by the service analysis engine.

9. The method of claim 1, wherein the one or more assigned tasks are assigned to each worker by the service analysis engine.

10. The method of claim 1, wherein:
the one or more tools comprises one or more software applications;
the one or more workers comprises one or more human resources; and
wherein the one or more agents comprises one or more software sensors.

11. A service analysis engine embodied in computer-readable medium and operable, when executed, to:
collect metrics corresponding to the use of one or more software applications by one or more human resources, each human resource having one or more assigned tasks corresponding to a service, the metrics communicated by one or more agents;
normalize the metrics using one or more first characteristics of the one or more software applications and one or more second characteristics of the one or more human resources;
correlate the metrics using one or more algorithms to provide one or more outputs; and
generate a report based on the one or more outputs for communication to a client.

12. The service analysis engine of claim 11, wherein the service analysis engine is further operable to communicate, using at least the client, at least a portion of the generated report to at least one human resource of the one or more human resources.

13. The service analysis engine of claim 11, wherein the service analysis engine is further operable to modify at least one task of the one or more assigned tasks corresponding to the service, the modification based at least in part on the correlated metrics.

14. The service analysis engine of claim 11, wherein the generated report comprises information pertaining to a level of efficiency for at least one worker of the one or more workers.

15. The service analysis engine of claim 11, wherein the generated report comprises information pertaining to a level of quality for each worker of the one or more workers.

16. The service analysis engine of claim 11, wherein the generated report comprises information pertaining to a fee for the service.

17. The service analysis engine of claim 11, wherein the generated report comprises information pertaining to a level of efficiency for at least one tool of the one or more tools.

18. The service analysis engine of claim 11, wherein the service analysis engine is further operable to determine a level of quality for each tool of the one or more tools, the level of quality based at least in part on the correlated metrics.

19. The service analysis engine of claim 11, wherein the generated report comprises information pertaining to an estimated completion of at least one task of the one or more assigned tasks.

20. A system for managing a service, comprising:
one or more human resources each operable to perform one or more tasks using one or more tools, wherein a service is rendered by completing at least some of the one or more tasks performed by at least one of the human resources;
one or more agents operable to communicate metrics to a server corresponding to the use of the one or more tools by each human resource; and
a service analysis engine in communication with the server, the service analysis engine operable to:
collect the metrics communicated by the one or more agents;
normalize the metrics using one or more first characteristics of the one or more software applications and one or more second characteristics of the one or more human resources;
correlate the metrics using one or more algorithms to provide one or more outputs; and
generate a report based on the one or more outputs for communication to a client.
